(19) United States
(12) Patent Application Publication
(10) Pub. No.: US 2021/0079883 A1
(43) Pub. Date: Mar. 18, 2021

(54) Noise Reduction Surface Treatment for Airfoil

(71) Applicant: Virginia Tech Intellectual Properties, Inc., Blacksburg, VA (US)

(72) Inventors: William Nathan Alexander, Blacksburg, VA (US); William J. Devenport, Blacksburg, VA (US); Ian A. Clark, Blacksburg, VA (US); Justin W. Jaworski, Blacksburg, VA (US); Stewart Glegg, Blacksburg, VA (US); Nigel Peake, Blacksburg, VA (US); Conor Daly, Blacksburg, VA (US)

(73) Assignee: Virginia Tech Intellectual Properties, Inc., Blacksburg, VA (US)

(21) Appl. No.: 16/779,095

(22) Filed: Jan. 31, 2020

Related U.S. Application Data
(63) Continuation of application No. 15/308,181, filed on Nov. 1, 2016, now abandoned.
(60) Provisional application No. 61/985,507, filed on Apr. 29, 2014.
(60) Provisional application No. 62/020,654, filed on Jul. 3, 2014.

(51) Int. Cl. F03D 1/06

(52) U.S. Cl. CPC F03D 1/0633; F03D 1/0675; Y02E 10/72; F05B 2240/30; F05B 2260/962

(57) ABSTRACT

The present invention relates to airfoils having surface treatments to reduce trailing edge noise. The surface treatment is designed to reduce trailing edge noise by modifying the boundary layer turbulence as it approaches the trailing edge. The surface treatment accomplishes its function by breaking up spanwise-oriented turbulence approaching the trailing edge, thereby reducing the spanwise correlation lengthscales; deflecting the boundary layer turbulence away from the edge; and/or creating spanwise vortices or instability waves to reduce the turbulence-edge interaction.

This application claims the priority of U.S. Provisional Patent Application Nos. 61/985,507, filed Apr. 29, 2014, and 62/020,654, filed Jul. 3, 2014, which are incorporated herein by reference.

This invention was made with government support under contract number N00014-13-1-0244, N00014-14-1-0242, and N62909-12-1-7116 awarded by The U.S. Department of the Navy, Office of Naval Research. The government has certain rights in the invention.

### FIELD OF THE INVENTION

The present disclosure relates in general to airfoils. In particular, the present invention relates to airfoils having surface treatments to reduce trailing edge noise.

### BACKGROUND OF THE INVENTION

Trailing edge noise is a significant contributor to the total sound production of airfoils and therefore is of interest to many government and commercial programs. For example, with the spread of wind farms across the nation, local communities have expressed concern with regard to the environmental impact of these projects including noise pollution. Trailing-edge noise is the major noise source produced by wind turbines. Therefore, the reduction of this noise source is vital to the industry's continued growth, and to future reductions in the cost per kWh of wind energy.

Trailing edge noise is created by the interaction of turbulence in the boundary layer of an airfoil with the edge discontinuity which acts to convert the near-field pressure fluctuations to acoustic waves that then radiate to the far field. Oerlemans et al. (J. Sound Vibration, vol. 299, 2007, pp. 869-883) present acoustic maps of a wind turbine in operation that clearly identify the trailing edge source as the greatest producer of noise over other blade self-noise and inflow turbulence noise mechanisms for a wind turbine in steady conditions. They used a 148-microphone phased array to record the noise from a 58 m diameter Gamesa G58 wind turbine. Measured acoustic maps of the turbine show the majority of noise coming from the outer portion of the blade span, not the tip, with a directivity pattern and spectral scaling consistent with that of trailing edge noise.

Most trailing edge noise reduction attempts focus on treating the scattering discontinuity (e.g. serrated, porous, and compliant trailing edges). Each of these treatments has been shown to produce modest reductions in trailing edge noise although with some drawbacks. Serrated edges were analyzed theoretically by Howe (J. Fluid Struct., vol. 5, 1991, pp. 33-45). Howe (J. Sound Vibration, vol. 61 (3), 1978, pp. 437-465) concluded that trailing edge noise is proportional to the turbulence correlation length in the axis parallel to the scattering edge. Howe (J. Fluid Struct., vol. 5, 1991. pp. 33-45) determined that the effective length of this scattering edge can be reduced by incorporating serrations, since the principle component of the radiating sound is due to geometric instances which align the wavenumber of the convected turbulence normal to the edge. For an airfoil, two boundary layers with different characteristics encounter the trailing edge from the suction and pressure sides. Therefore, the serration dimensions have to be optimized for either the pressure or suction side boundary layer. Oerlemans et al. (AIAA Journal, vol. 47 (6), 2009, pp. 1470-1481) studied experimentally the application of trailing edge serrations on a 2.3 MW General Electric wind turbine with a rotor diameter of 94 m. The trailing edge serrations were effective in reducing the low frequency trailing edge noise associated with the suction side boundary layer but did have the unintended effect of increasing high frequency tip noise. Also, serrations have been shown to increase high frequency noise if misaligned with the trailing edge streamlines (Gruber et al., AIAA-2011-2781, June, 2011).

Porous trailing edges have been studied by Hayden (AIAA-1976-500, July, 1976) and Bohn (AIAA-1976-80, January, 1976), but again the effectiveness of the edge treatment was found to be dependent on turbulence length scales. Crighton and Leppington (J. Fluid Mech., vol. 43 (4), 1970, pp. 721-736) and Howe (Proc. R. Soc. Lond A, vol. 442, 1993, pp. 533-554) investigated the noise produced through diffraction by a compliant trailing edge. They found that a flexible trailing edge reduces the acoustic efficiency of the source only if the fluid loading is large, typical for marine applications not aeronautical problems. A final method of trailing edge noise reduction to note is the use of trailing edge combs or brushes which is a combination of the porous and compliant trailing edge concepts. This method has been investigated theoretically (Jaworski and Peake, J. Fluid Mech., vol. 723, 2013, pp. 456-479) and experimentally with successful lab performance (Herr and Dobrzynski, AAIA Journal, vol. 43 (6), 2005, pp. 1167-1175; Herr, AIAA-2007-3470, May, 2007; Finez et al., AIAA-2010-3980, June, 2010), but hasn't functioned well in practice, even increasing noise (Schepers et al., Proc. of the Second International Meeting on Wind Turbine Noise, September, 2007).

Therefore, there remains a need for airfoils with a surface treatment for reducing trailing edge noise by attenuating the boundary layer pressure fluctuations upstream and to reduce the spanwise correlation of turbulent structures impacting the trailing edge.

### SUMMARY OF THE INVENTION

The present invention relates to airfoils having surface treatment thereon to reduce trailing edge noise. The surface treatment reduces trailing edge noise by modifying the boundary layer turbulence as it approaches the trailing edge. The surface treatment accomplishes its function by breaking up spanwise-oriented turbulence approaching the trailing edge, thereby reducing the spanwise correlation lengthscales; deflecting the boundary layer turbulence away from the edge; and/or creating spanwise vortices or instability waves that reduce the turbulence-edge interaction. The airfoil treatment of the present invention is particularly useful on wind turbine rotor blades, but also in many other applications where trailing edge noise is important. These other applications include but are not limited to; aircraft engines, aircraft wings, helicopter blades, jet engine fan blades, hydrofoils and fan blades and flow surfaces such as used in automotive, domestic appliance, equipment cooling, HVAC and other applications.

An airfoil is disclosed having exterior surfaces defining a pressure side, a suction side, a leading edge and a trailing edge each extending between a tip and a root. The airfoil further defines a span and a chord. The airfoil assembly further includes a noise reducer configured on the pressure side and/or the suction side. The noise reducer includes a plurality of members, extending approximately in the direction of flow toward the trailing edge and is distributed spanwise across the pressure side and/or suction side of the airfoil. Each noise reducing member is preferably an elongated element (e.g. ridges, fins, or filaments) with one end mounted approximately at the trailing edge of the airfoil, and the other end extending upstream of the trailing edge in the direction of airflow.

In one embodiment, the noise reducer member includes a rail configuration holding a filament at a predetermined height off the surface (pressure side and/or suction side) of the airfoil. The filament is relatively thin, preferably having diameter less than 100% of the boundary layer thickness. The filament is held above the surface by one or more supporting posts that anchor the filament to the surface. Typically, the filament is held at a height (above the surface) of about 5-300%, preferably about 30-200%, of the trailing edge boundary layer thickness at the designed operating condition of the airfoil. The rail configuration extends up to 40% of the chord of the airfoil upstream of the trailing edge in the direction of airflow.

In another embodiment, a noise reducer member includes a fin extending vertically from the surface (pressure side and/or suction side) of the foil. The fin is thin, preferably having a thickness less than the boundary layer thickness. Typically, the fin extends to a maximum height (above the surface) of about 5-300%, preferably about 30-200%, of the trailing edge boundary layer thickness at the designed operating condition of the airfoil. The fin also extends up to 40% of the chord of the airfoil upstream of the trailing edge in the direction of airflow.

These and other features, aspects and advantages of the present invention will become better understood with reference to the following drawings and detailed description. The accompanying drawings illustrate embodiments of the invention and, together with the description, serve to explain the principles of the invention.

### BRIEF DESCRIPTION OF THE DRAWINGS

FIG. 1 is drawing showing a typical airfoil.

FIG. 2 is a drawing showing the top view of an airfoil having noise reducers adjacent to the trailing edge.

FIG. 3 is a drawing showing a side view of a rail configuration.

FIG. 4 is a drawing showing a side view of a fin configuration.

FIG. 5 is a drawing showing rails mounted on the trailing edge of an airfoil.

FIG. 6 is drawing showing fins mounted on the trailing edge of an airfoil

FIG. 7 is a graph showing a comparison of the coefficient of lift (Cₗ) versus angle of attack (AoA, in degrees) of the airfoil of Configuration 5 and a clean airfoil.

FIG. 8 is a graph showing noise levels at different frequencies of the airfoil of Configuration 5 and a clean airfoil at an angle of attack of −2.5°.

FIG. 9 is a graph showing noise levels at different frequencies of the airfoil of Configuration 5 and a clean airfoil at an angle of attack of 0°.

FIG. 10 is a graph showing noise levels at different frequencies of the airfoil of Configuration 5 and a clean airfoil at an angle of attack of 4°.

FIG. 11 is a graph showing noise levels at different frequencies of the airfoil of Configuration 5 and a clean airfoil at an angle of attack of 8°.

FIG. 12 is a graph showing the coefficient of lift (Cₗ) versus angle of attack (AoA, in degrees) of the airfoil of Configurations 3, 5, 7, and 13, and a clean airfoil. These configurations represent the same fin design but with different spanwise spacing between the fins indicated in the legend.

FIG. 13 is a graph showing noise levels at different frequencies of the airfoil of Configuration 3, 5, 7, and 13, and a clean airfoil at an angle of attack of −2.5°. These configurations represent the same fin design but with different spanwise spacing between the fins indicated in the legend.

FIG. 14 is a graph showing noise levels at different frequencies of the airfoil of Configurations 3, 5, 7, and 13, and a clean airfoil at an angle of attack of 0°. These configurations represent the same fin design but with different spanwise spacing between the fins indicated in the legend.

FIG. 15 is a graph showing noise levels at different frequencies of the airfoil of Configurations 3, 5, 7, and 13, and a clean airfoil at an angle of attack of 4°. These configurations represent the same fin design but with different spanwise spacing between the fins indicated in the legend.

FIG. 16 is a graph showing noise levels at different frequencies of the airfoil of Configuration 3, 5, 7, and 13, and a clean airfoil at an angle of attack of 8°. These configurations represent the same fin design but with different spanwise spacing between the fins indicated in the legend.

FIG. 17 is a graph showing the coefficient of lift (Cₗ) versus angle of attack (AoA, in degrees) of the airfoil of Configurations 1 and 3, and a clean airfoil. These configurations represent the same fin design but with the fin ending at the trailing edge or extending beyond it.

FIG. 18 is a graph showing noise levels at different frequencies of the airfoil of Configurations 1 and 3, and a clean airfoil at an angle of attack of 4°. These configurations represent the same fin design but with the fin ending at the trailing edge or extending beyond it.

FIG. 19 is a graph showing the coefficient of lift (Cₗ) versus angle of attack (AoA, in degrees) of the airfoil of Configurations 5, and 8, and a clean airfoil. These configurations represent the same fin design but with different maximum fin heights above the airfoil surface.

FIG. 20 is a graph showing noise levels at different frequencies of the airfoil of Configurations 5, and 8, and a clean airfoil at an angle of attack of 4°. These configurations represent the same fin design but with different maximum fin heights above the airfoil surface.

FIG. 21 is a graph showing the coefficient of lift (Cₗ) versus angle of attack (AoA, in degrees) of the airfoil of Configurations 3, 6, and 12, and a clean airfoil. These configurations represent the same fin design but with different periodic spanwise variations in fin height and/or length.

FIG. 22 is a graph showing noise levels at different frequencies of the airfoil of Configurations 3, 6, and 12, and a clean airfoil at an angle of attack of 4°. These configurations represent the same fin design but with different periodic spanwise variations in fin height and/or length.

FIG. 23 is a graph showing the coefficient of lift (Ci) versus angle of attack (AoA, in degrees) of the airfoil of Configurations 8 and 8S, and a clean airfoil. These configurations represent the same fin design and show the difference in applying the fins to one side versus both sides of the airfoil.

FIG. 24 is a graph showing noise levels at different frequencies of the airfoil of Configurations 8 and 8S, and a clean airfoil at an angle of attack of 4°. These configurations represent the same fin design and show the difference in applying the fins to one side versus both sides of the airfoil.

FIG. 25 is a graph showing the coefficient of lift (Cₗ) versus angle of attack (AoA, in degrees) of the airfoil of Configurations 5 and 9, and a clean airfoil. These configurations represent the same fin design except that the fins are of different thickness.

FIG. 26 is a graph showing noise levels at different frequencies of the airfoil of Configurations 5 and 9, and a clean airfoil at an angle of attack of 4°. These configurations represent the same fin design except that the fins are of different thickness.

FIG. 27 is a graph showing the coefficient of lift (Cₗ) versus angle of attack (AoA, in degrees) of the airfoil of Configurations 3, 5, and 14, and a clean airfoil. These configurations compare the results obtained using two different fin designs and one of the rail designs.

FIG. 28 is a graph showing noise levels at different frequencies of the airfoil of Configurations 3, 5, and 14, and a clean airfoil at an angle of attack of 4°. These configurations compare the results obtained using two different fin designs and one of the rail designs.

FIG. 29 is a graph showing the coefficient of lift (Cₗ) versus angle of attack (AoA, in degrees) of the airfoil of Configurations 14, 15, 17, 18, 19, and 20, and a clean airfoil. These configurations represent a wide variety of rail designs.

FIG. 30 is a graph showing noise levels at different frequencies of the airfoil of Configurations 14, 15, 17, 18, 19, and 20, and a clean airfoil at an angle of attack of −2.5°. These configurations represent a wide variety of rail designs.

FIG. 31 is a graph showing noise levels at different frequencies of the airfoil of Configurations 14, 15, 17, 18, 19, and 20, and a clean airfoil at an angle of attack of 0°. These configurations represent a wide variety of rail designs.

FIG. 32 is a graph showing noise levels at different frequencies of the airfoil of Configurations 14, 15, 17, 18, 19, and 20, and a clean airfoil at an angle of attack of 4°. These configurations represent a wide variety of rail designs.

FIG. 33 is a graph showing noise levels at different frequencies of the airfoil of Configurations 14, 15, 17, 18, 19, and 20, and a clean airfoil at an angle of attack of 8°. These configurations represent a wide variety of rail designs.

### DETAILED DESCRIPTION

The present invention relates to airfoils having surface treatments to reduce trailing edge noise. The surface treatment is designed to reduce trailing edge noise by modifying the boundary layer turbulence as it approaches the trailing edge. The surface treatment accomplishes its function by breaking up spanwise-oriented turbulence approaching the trailing edge, thereby reducing the spanwise correlation lengthscales; deflecting the boundary layer turbulence away from the edge; and/or creating spanwise vortices or instability waves that reduce the turbulence-edge interaction.

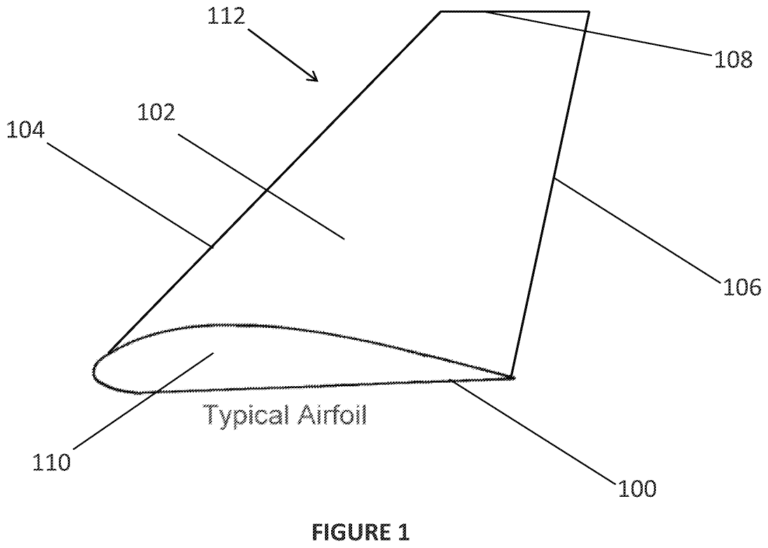

Referring to FIG. 1, there is shown an airfoil 112 having exterior surfaces defining a pressure side 100, a suction side 102, a leading edge 104, and a trailing edge 106 each extending between a tip 108 and a root 110. The airfoil further defines a span and a chord. The airfoil further includes a noise reducer configured on the pressure side surface 100 and/or the suction side surface 102.

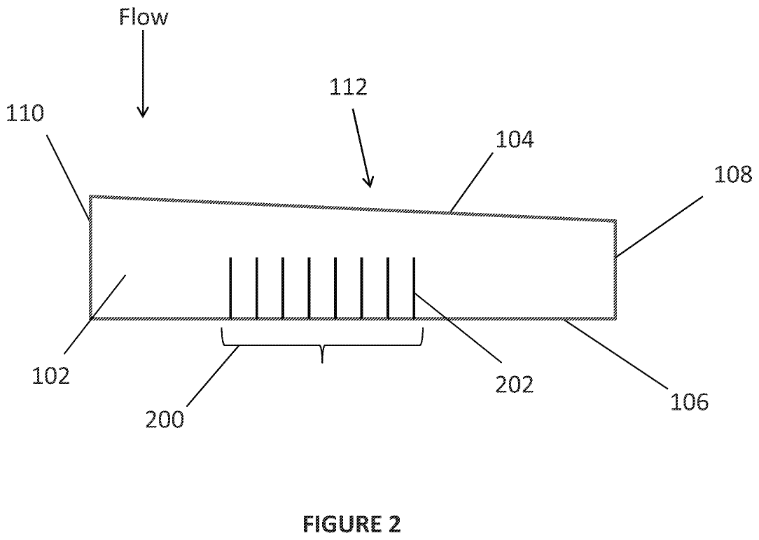

FIG. 2 shows a top view of the airfoil 112 having a noise reducer 200 on the suction side 102. The noise reducer includes a plurality of members 202 extending lengthwise (L) in the direction of flow toward the trailing edge 106 and approximately perpendicular to the surface (pressure side and/or suction side) of the airfoil. The noise reducer members 202 are preferably distributed spanwise across the foil. The noise reducer 200 may be connected to the airfoil 112 during the manufacture of the airfoil, or may be retro-fitted to existing airfoils. Each noise reducer member is preferably an elongated element (e.g. ridges, fins, or filaments) having one end mounted approximately at the trailing edge of the airfoil, and the other end extending upstream of the trailing edge in the direction of airflow.

The noise reducer 200 may be formed on the airfoil 112 adjacent to the trailing edge 106 and on the suction side 102, the pressure side 100, or both. In certain application, the noise reducer 200 may extend slightly beyond the trailing edge 106. Alternatively, it may be slightly short of the trailing edge 106. Nevertheless, it is desirable to have the noise reducer be as close as possible to the trailing edge 106.

The noise reducer 200 may be located along any suitable portion of the span of the airfoil 112. The noise reducer 200 may be placed along the whole span of the airfoil 112 or only at selected portions along the span. The placement of the noise reducer 200 depends largely on the application of the airfoil 112. For example, for wind turbine applications, it may be preferred that the noise reducer 200 is placed at or near the tip of the airfoil 112, because most of the trailing edge noise occurs closer to the tip of the airfoil 112 as it turns on a wind turbine. Depending on the application, it is preferred that the noise reducer 200 is placed, at a minimum, along the trailing edge 106 of the airfoil 112 where the most intense or most audible trailing edge noise is produced. In exemplary embodiments, the noise reducer 200 may be located entirely within the outer board area closest to the tip 108. In particular, the noise reducer 200 may be located entirely within approximately 30% of the span of the airfoil 112 from the tip 108. In other embodiments, however, the noise reducer 200 may be located entirely within approximately 33%, approximately 40%, or approximately 50% of the span of the airfoil 112 from the tip 108. In still other embodiments, the noise reducer 200 may be located entirely within a suitable portion of the inner board area closest to the root 110, or within suitable portions of both the inner board area and outer board area, or somewhere in the middle.

Each of the noise reducer members 202 is aligned approximately parallel to the direction of air flow. The noise reducer members 202 are spaced from each other at an interval that is typically less than 300% of the local boundary layer thickness. The noise reducer 200 preferably contains sufficient members 202 to achieve this spacing across the entire treated portion of the span. It is important to note here that the noise reducer members 202 should not be so close together that they act essentially as a unitary object when air flow encounters the members. The noise reducer member 202 rises from the surface (pressure side and/or suction side) of the airfoil 112 a maximum height of about 5-300%, preferably about 30-200%, of the trailing edge boundary layer thickness at the designed operating condition of the airfoil. The member 202 extends up to 40% of the chord of the airfoil upstream of the trailing edge in the direction of airflow. Although that length is preferably uniform, in certain applications, the members 202 may have different lengths.

In many embodiments each of the members 202 may be formed of a rigid material. In other embodiments some or all of the members may be made from an elastic material that allows the members to flex to accommodate misalignments in the flow direction and the alignment of the members. Such flexible members will have a flexibility that is sufficient to allow them to flex with any overall flow misalignment, but insufficient for them to flex under the action of turbulence in the airfoil boundary layers.

In some embodiments, for example, each of the members 202 may be formed from suitable metals, plastic, or fiber-reinforced plastic (“FRP”) material. The fiber may be, for example, glass, basalt, carbon, polyimide, or polyethylene, such as ultra-high molecular weight polyethylene, or any other suitable fiber. The plastics may be, for example, epoxy, vinylester, polypropylene, polybutylene tcrephthalatc, polyethylene, or polyamide, or any other suitable plastic material. In other embodiments, the member 202 may be formed from a suitable polyamide or polypropylene material. In still other embodiments, the member 202 may be formed from a suitable metal or metal alloy. It should be understood, however, that the present disclosure is not limited to the above-disclosed materials or material properties, and rather that any suitable materials having any suitable material properties are within the scope and spirit of the present disclosure.

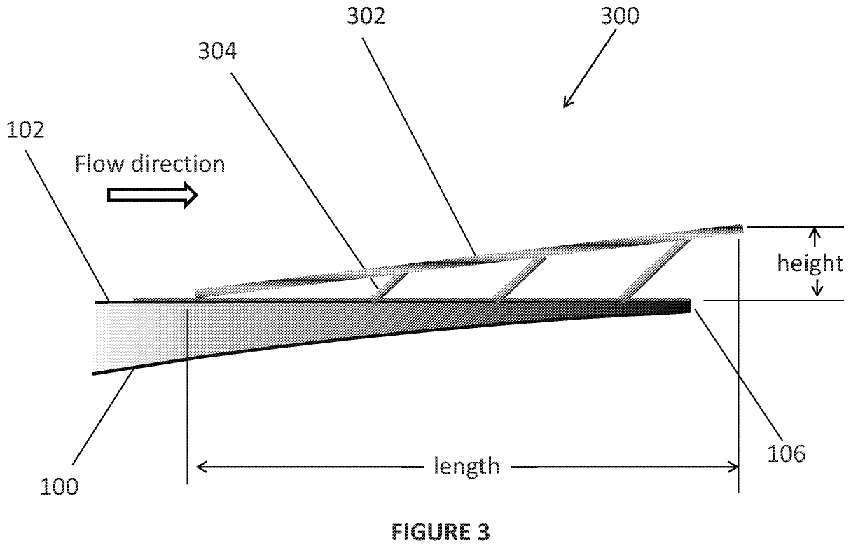

In one embodiment, as illustrated in FIG. 3, the noise reducer member 202 includes a rail configuration 300 holding a filament 302 of length L at a predetermined maximum height H off the surface (pressure side 100 and/or suction side 102) of the airfoil 112. Although FIG. 3 illustrates the noise reducer member 202 being attached to the suction side 102, it may also be attached to the pressure side 100, or on both sides of the airfoil 112. The filament 302 is relatively thin, preferably having diameter of less than about 100% of the boundary layer thickness. The filament 302 is held above the surface by one or more supporting posts 304 that anchor the filament 302 to the surface. Typically, the filament is held at a height (above the surface) of about 5-300%, preferably about 30-200%, of the trailing edge boundary layer thickness at the designed operating condition of the airfoil 112. The rail 300 has a length L of up to about 40% of the chord of the airfoil, and extends up to about 40% chord upstream of the trailing edge in the direction of airflow.

As shown in FIG. 3, the filament 302 is attached to the surface of the airfoil 112 toward the leading edge 104, raises to a maximum height H toward the trailing edge 106, and has a length L. The filament 302 and its supports 304 may be attached directly to the airfoil surface or to a thin substrate 306 designed to ease manufacture or attachment. Although FIG. 3 illustrates the noise reducer member being attached to the suction side 102, it may also be attached to the pressure side 100, or on both sides of the airfoil 112. Although FIG. 3 shows a preferred configuration for the filament, other configurations may also be possible. For example, a filament being kept at a constant height above the airfoil 112 is also appropriate for the present invention.

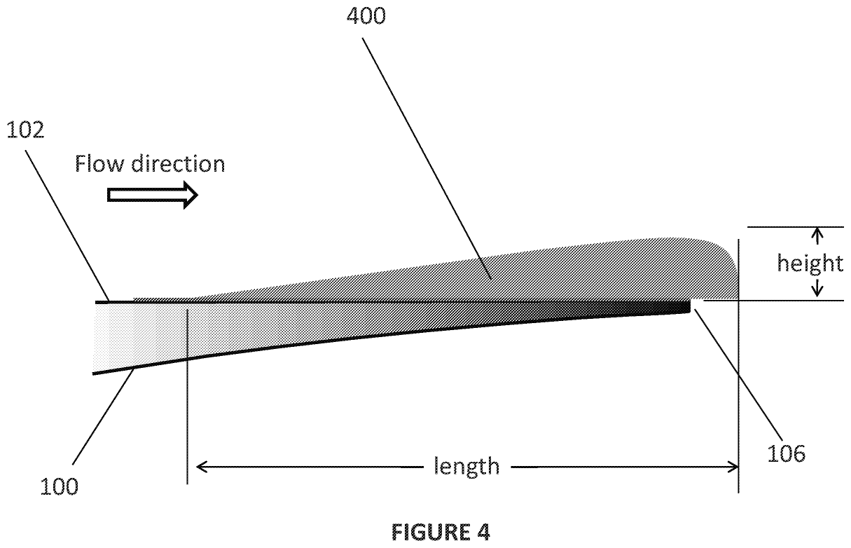

In another embodiment, as illustrated in FIG. 4, a noise reducer member 202 includes a fin 400 extending approximately perpendicular from the surface (pressure side 100 and/or suction side 102) of the airfoil 112. Again a substrate 406 may be used. Although FIG. 4 illustrates the noise reducer member being attached to the suction side 102, it may also be attached to the pressure side 100, or on both sides of the airfoil 112. The fin 400 is thin, preferably having a thickness of less than 100% of the boundary layer thickness. Typically, the fin 400 extends to a maximum height H (above the surface) of about 5-300%, preferably about 30-200%, of the trailing edge boundary layer thickness at the designed operating condition of the airfoil 112. The fin 400 also has a length L of up to about 40% of the chord of the airfoil, and extends up to about 40% chord upstream of the trailing edge in the direction of airflow. The fin may have different cross-sectional shapes. For example, FIG. 4 shows the fin as a blade with approximately a rectangular cross-section, however, other cross-sectional shapes are also appropriate, such as substantially elliptical, circular, triangular, or combinations thereof, are also appropriate.

As also shown in FIG. 4, the fin 400 has a substantially triangular shape that raises to a maximum height H toward to the trailing edge 106. Although this is a preferred fin configuration, other configurations may also be possible. For example, a substantially rectangular or trapezoidal shaped fin is also appropriate for the present invention.

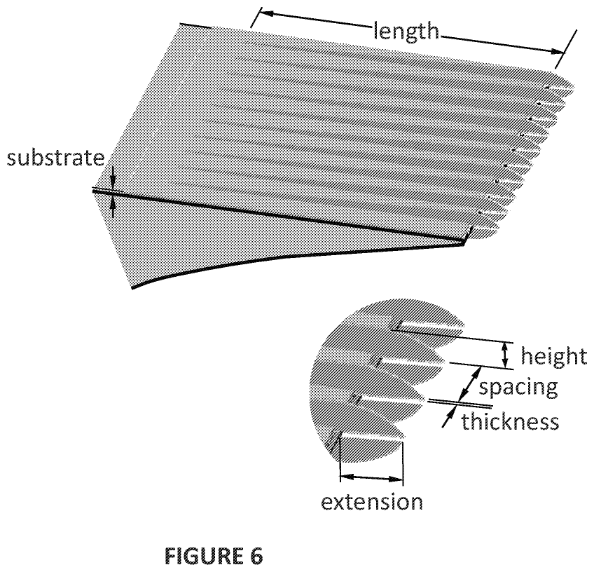

As also shown in FIG. 6, the fin has a thin rectangular form when viewed in a cross section perpendicular to the flow direction. This is only one of a number of suitable cross-sectional shapes. For example, rectangular, square, triangular or other polygonal shapes may be possible, as well as circular, elliptical, Gaussian or other rounded shapes. Rounded cross sectional shapes may be advantageous in tolerating misalignment between the flow and the fins.

Without further description, it is believed that one of ordinary skill in the art can, using the preceding description and the following illustrative example, make and utilize the device of the present invention and practice the claimed methods. The following example is given to illustrate the present invention. It should be understood that the invention is not to be limited to the specific conditions or details described in this example.

### Example

Trailing edge noise was measured from a DU96W180 wind turbine blade model with 0.8 m chord and a span of 1.83 m with and without sample surface treatment with noise reducers. The boundary layers on the airfoil were tripped using zigzag tape placed in the vicinity of its leading edge. Noise reducers having the rail configuration and the fin configuration were tested. Several variations of each configuration were examined. Tables 1 and 2 list the examined surfaces. All treatments were tested at free-stream flow speeds of 50 and 60 m/s, corresponding to chord Reynolds numbers of 2.5 million and 3.0 million respectively. Results below are shown for a chord Reynolds number of 3.0 million since they were substantially the same recorded at a Reynolds number of 2.5 million.

TABLE 1
Rail configurations (units are in mm)

| | | | | | | | Treatment both | |
|---|---|---|---|---|---|---|---|---|
| | | | | | TE | | sides (B) or | |
| Config# | Type | Height | Spacing | Diameter | extension | Length | suction only (S) | Comment |
| 14 | Rail | 4 | 2.5 | 1.25 | 10 | 114 | B | Rod anchor case |
| 15 | Rail | 4 | 2.5 | 1.25 | 0 | 114 | B | Effect of extension with config 14 |
| 17 | Rail | 8 | 2.5 | 1.25 | 10 | 114 | B | Effect of height with config 14 |
| 18 | Rail | 4 | 5 | 2.5 | 10 | 114 | B | Effect of dia. & spacing with config 14 |
| 20 | Rail | 8 | 10 | 1.25 | 10 | 114 | B | Effect of spacing with config 14 |
| 19 | Rail | 4 | 2.5 | 1.25 | 10 | Periodic | B | Effect of periodic length variation with config 14 |

TABLE 2
Fin configurations (units are in mm)

| | | | | | | | Treatment both | |
|---|---|---|---|---|---|---|---|---|
| | | | | | TE | | sides (B) or | |
| Config# | Type | Height | Spacing | Thickness | extension | Length | suction only (S) | Comment |
| 0 | — | — | — | — | — | — | — | Control cases including clean airfoil (config 0), |
| 2 | Blank | — | — | — | — | — | — | and airfoil with only 0.5 mm and 0.75-mm |
| 10 | Blank | — | — | — | — | — | — | treatment substrates (configs 2 and 10, respectively) |
| 3 | Fin | 4 | 1 | 0.5 | 10 | 114 | B | Fin anchor case |
| 1 | Fin | 4 | 1 | 0.5 | 0 | 114 | B | Effect of extension with config 3 |
| 5 | Fin | 4 | 4 | 0.5 | 10 | 114 | B | Effects of fin spacing with config 3 |
| 13 | Fin | 4 | 6 | 0.5 | 10 | 114 | B | |
| 7 | Fin | 4 | 10 | 0.5 | 10 | 114 | B | |
| 11 | Fin | 2 | 1 | 0.5 | 10 | 114 | B | Effects of height with config 3 |
| 6 | Fin | 4 | 1 | 0.5 | 10 | Periodic | B | Effect of periodic length with config 3 |
| 12 | Fin | Periodic | 1 | 0.5 | 10 | Periodic | B | Effect of periodic length/height with config 3 |
| 8 | Fin | 8 | 4 | 0.5 | 10 | 114 | B | Effect of fin height with config 5 |
| 9 | Fin | 4 | 4 | 2 | 10 | 114 | B | Effect of fin thickness with config 5 |
| 1S | Fin | 4 | 1 | 0.5 | 0 | 114 | S | Effect of no pressure side treatment config 1 |
| 3S | Fin | 4 | 1 | 0.5 | 10 | 114 | S | Effect of no pressure side treatment with config 3 |
| 8S | Fin | 8 | 4 | 0.5 | 10 | 114 | S | Effect of no pressure side treatment with config 5 |
| 26s | Fin | 16 | 4 | 0.5 | 0 | 114 | S | High suction-side treatment |

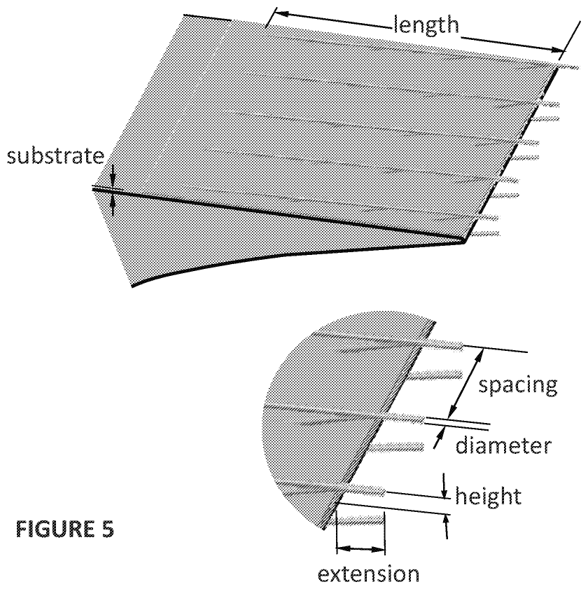

FIGS. 5 and 6 show the rail and fin configurations mounted in the vicinity of the trailing edge, respectively. All fin configurations contain noise reducers on the suction and pressure sides, except Configurations 15, 3S, and 8S.

The performance of the airfoil with these configurations attached were compared against those of the same foil without any noise reducers. For the fins, the effects of the following geometric variables were considered: spacing, trailing edge extension, suction side only attachment, fin thickness, height, periodic spanwise variations in length and/or height. For the rails, the effects of the following geometric variables were considered: spacing, trailing edge extension, filament diameter, height, and periodic spanwise variations in length. The effects were considered with regard to lift and noise reduction.

Measurements were completed with several rail/fin spacings, thicknesses, and depths. Also, the effect of a short trailing edge extension was also examined. The effect of adding a trailing edge extension, extending only 10 mm downstream of the trailing edge, was shown to be minimal. This confirms that the unsteady surface pressure attenuation and decorrelation of the spanwise eddy structure is the dominant factor in eliminating the trailing edge noise. This is a significant conclusion since surfaces without trailing edge extensions may not suffer from increased noise at high angles of attack like other trailing edge noise treatments such as feathered or serrated edges. Also, pressure distributions were measured on the airfoil and show that the applied surface treatments produce no significant influence on the airfoil performance.

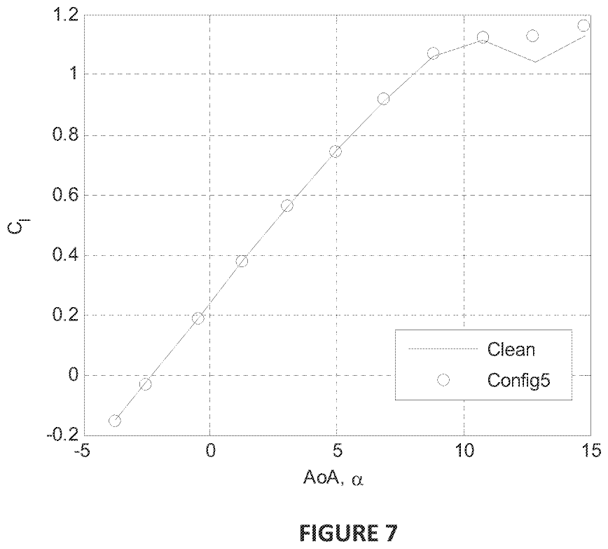

FIG. 7 shows the coefficient of lift (Cₗ) versus angle of attack (AoA) of the airfoil of Configuration 5 and the same airfoil without the noise reducer (clean). The noise reducer did not significantly affect lift.

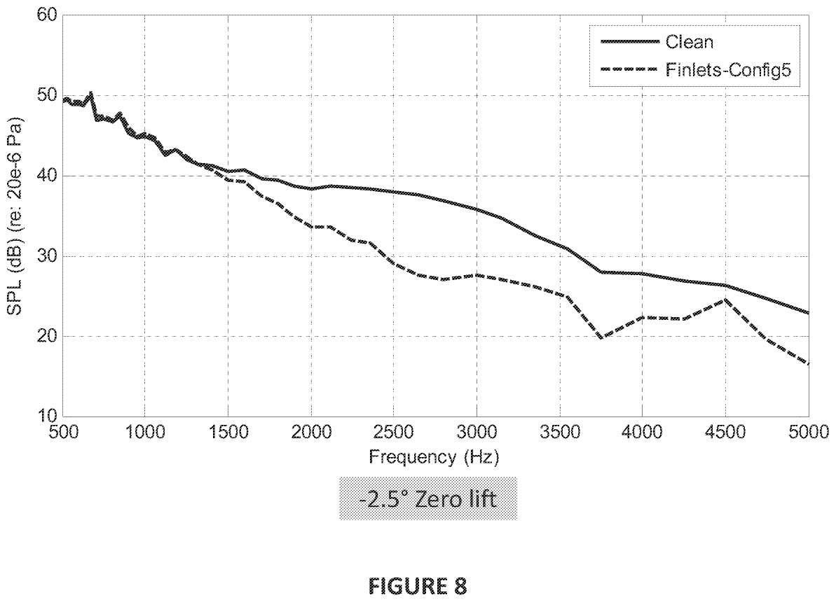

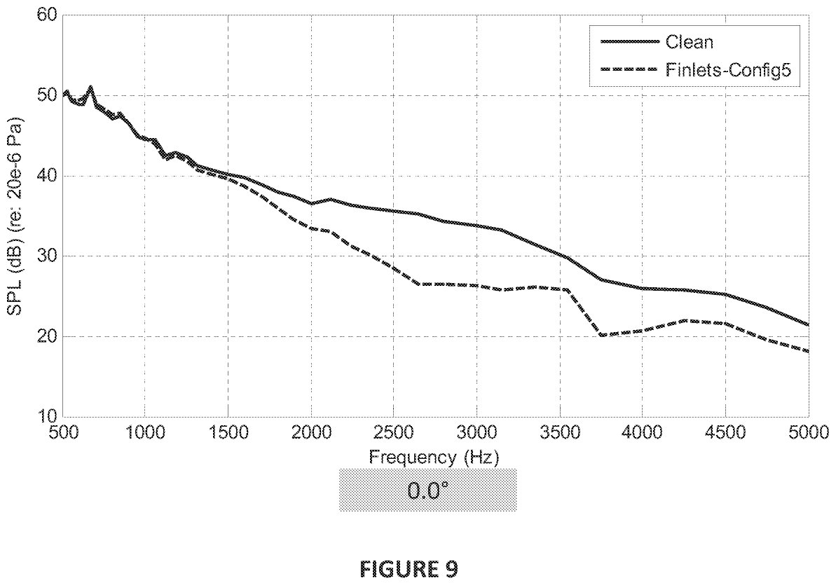

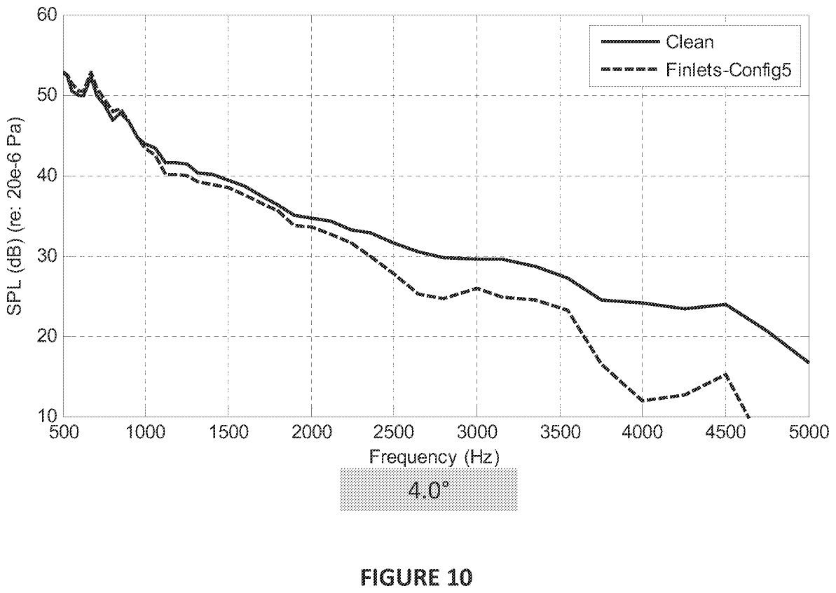

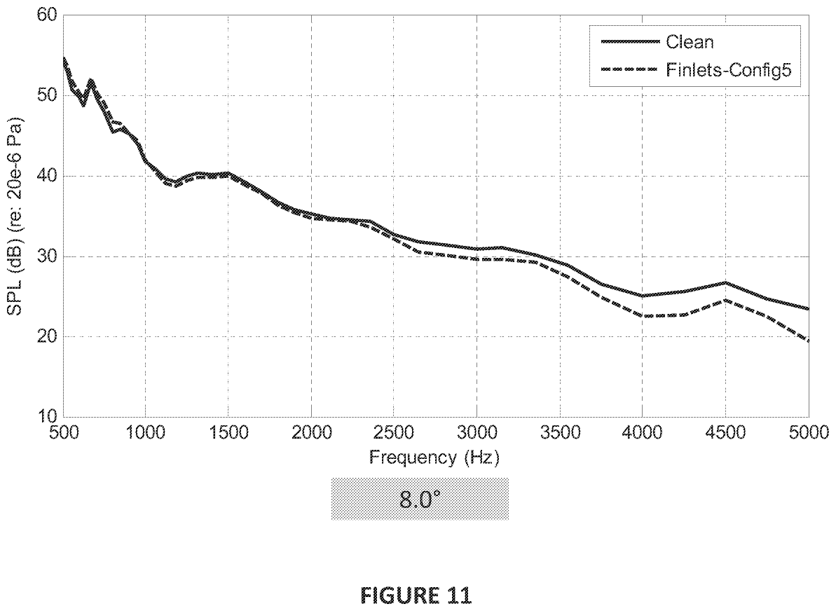

FIG. 8-11 show the trailing edge noise reduction of Configuration 5 at angles of attack of −2.5, 0, 4, and 8°, respectively. Substantial noise reduction has been achieved at least at frequency ranges above 1500 Hz for angles of attack of −2.5, 0, and 4°, as seen in FIGS. 8, 9, and 10. Limited noise reduction at higher frequencies is achieved for an angle of attack of 8° as seen in FIG. 11. Substantial noise reduction may also occur below 15001 Hz, though that cannot be established using the measurement technique employed in this experiment.

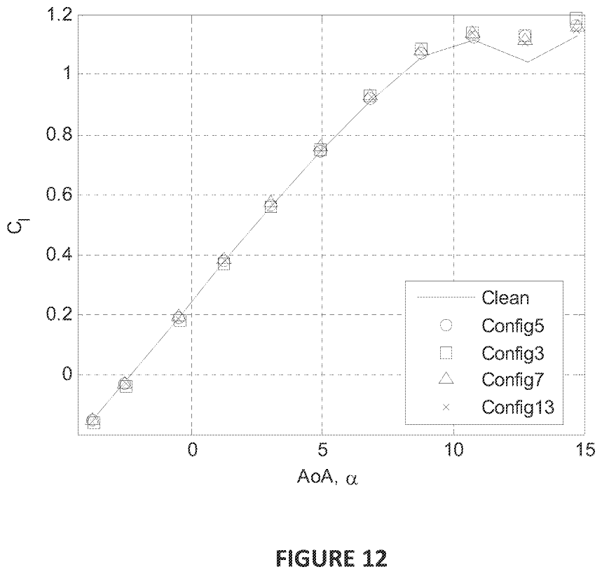

FIG. 12 shows the coefficient of lift (Cₗ) versus angle of attack (AoA) of the airfoil of Configurations 3, 5, 7, and 13, and the same airfoil without the noise reducer (clean). These configurations represent the same fin design but with different spanwise spacing between the fins indicated in the legend. The spacing between the individual fins did not significantly affect lift.

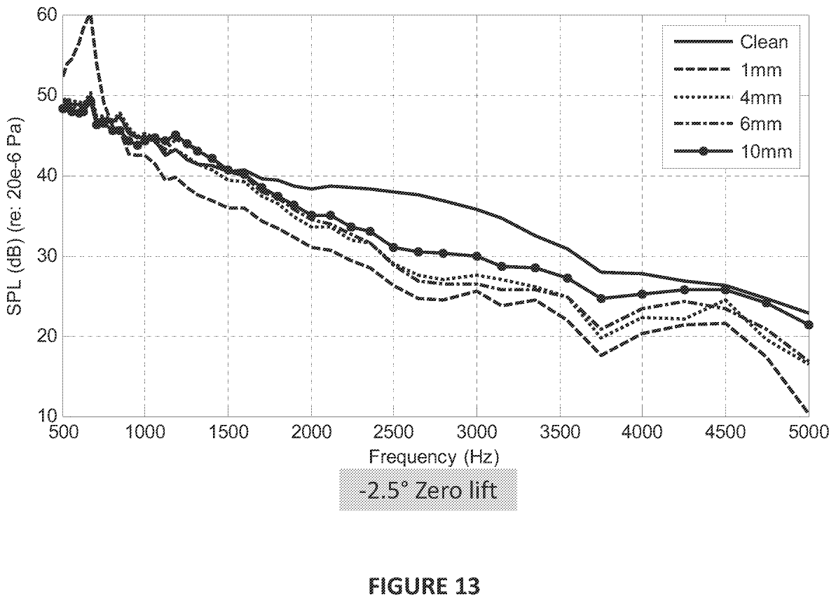

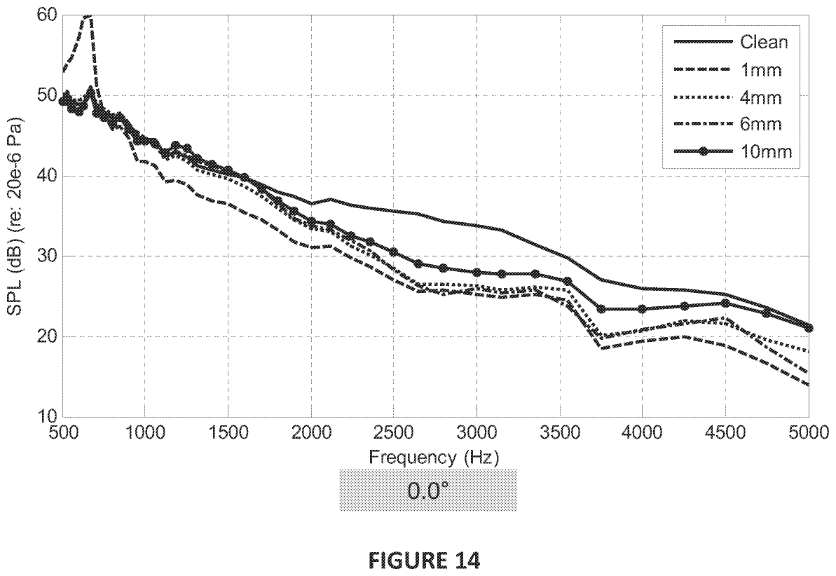

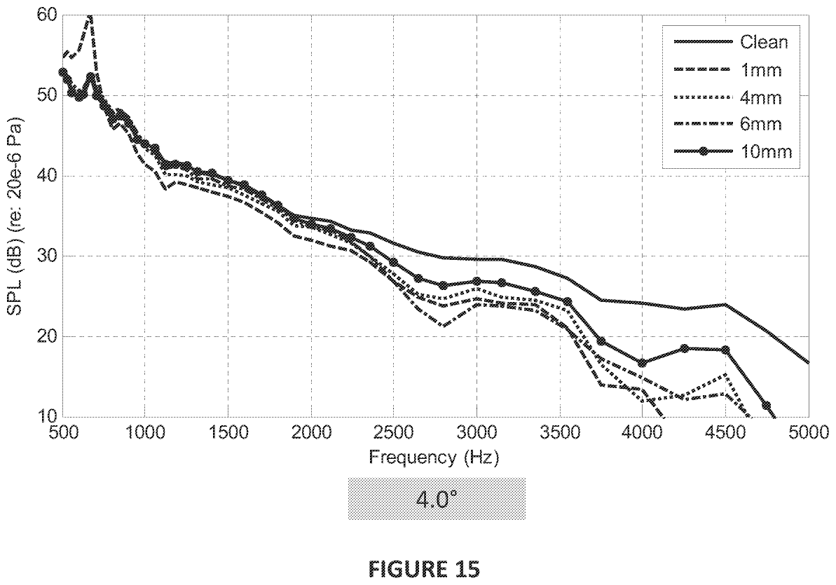

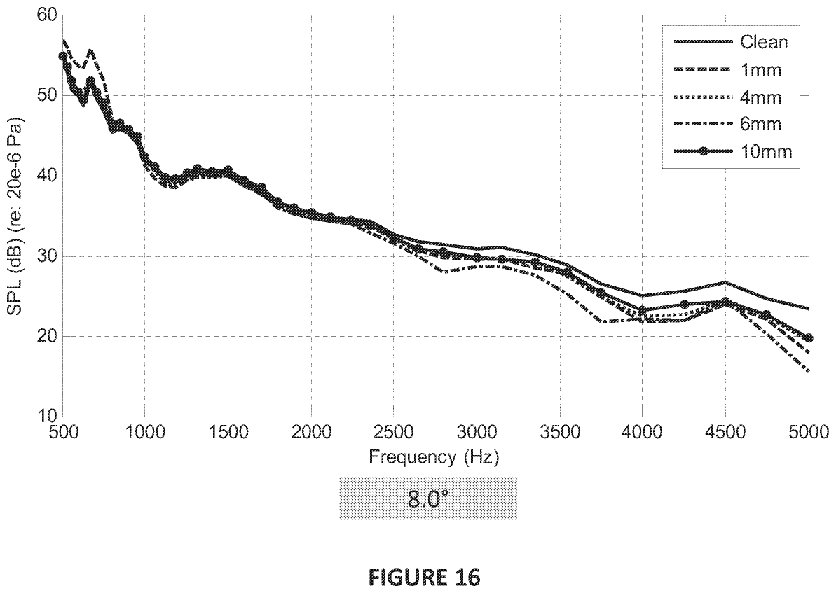

FIGS. 13-16 show the trailing edge noise reduction of Configurations 3, 5, 7, and 13 at angles of attack of −2.5, 0, 4, and 8° respectively. In general, the device becomes less effective as the spacing between the members is increased. Although the 1 mm spacing resulted in the greatest noise reduction across the majority of the frequency range, the noise spike near 650 Hz is likely the result of the flow viewing the trailing edge members as a unitary object as mentioned in Paragraph [0052].

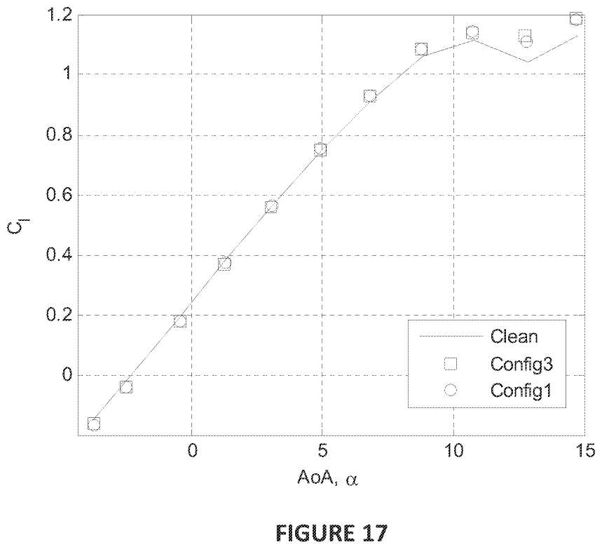

FIG. 17 shows the coefficient of lift (Cₗ) versus angle of attack (AoA, in degrees) of the airfoil of Configurations 1 and 3, and the same airfoil without the noise reducer (clean). These configurations represent the same fin design but with the fin ending at the trailing edge or extending beyond it. The trailing edge extension of the fins did not significantly affect lift.

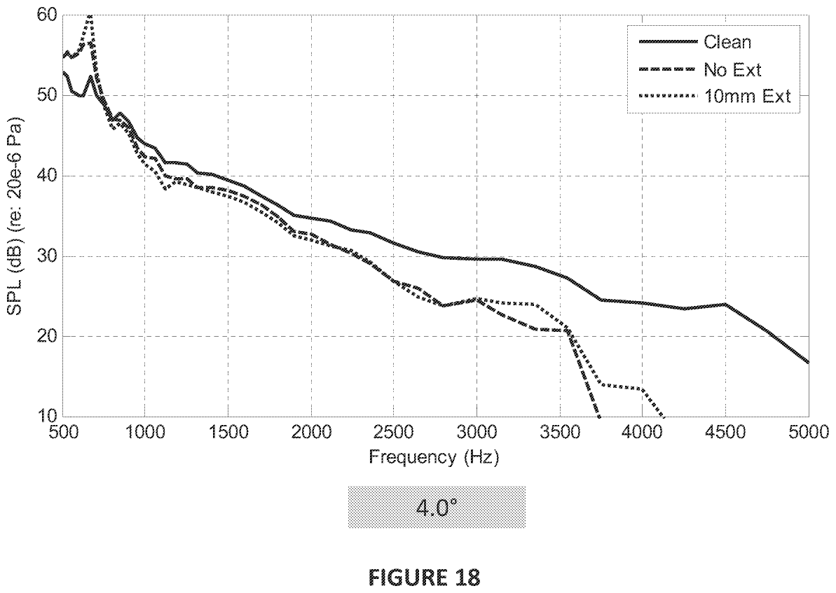

FIG. 18 shows the trailing edge noise reduction of Configurations 1 and 3 at an angle of attack of 4°. The 10 mm extension past the trailing edge showed no benefit to noise reduction, and the configuration with no extension performed better at higher frequencies.

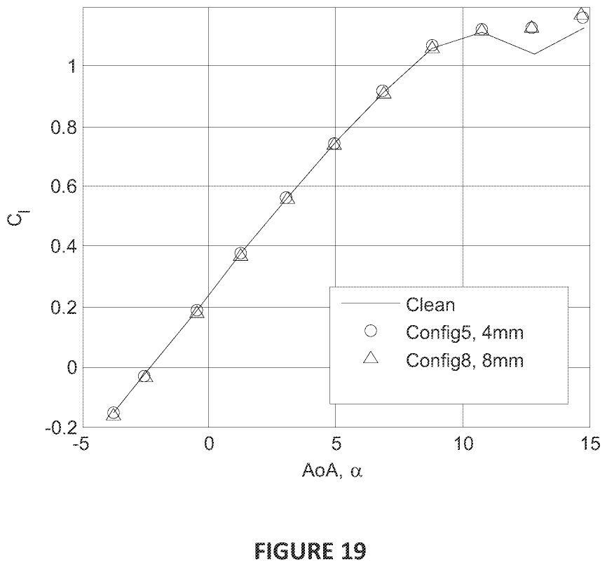

FIG. 19 shows the coefficient of lift (Cₗ) versus angle of attack (AoA, in degrees) of the airfoil of Configurations 5, and 8, and the same airfoil without the noise reducer (clean). These configurations represent the same fin design but with different maximum fin heights above the airfoil surface. The height of the fins did not significantly affect lift.

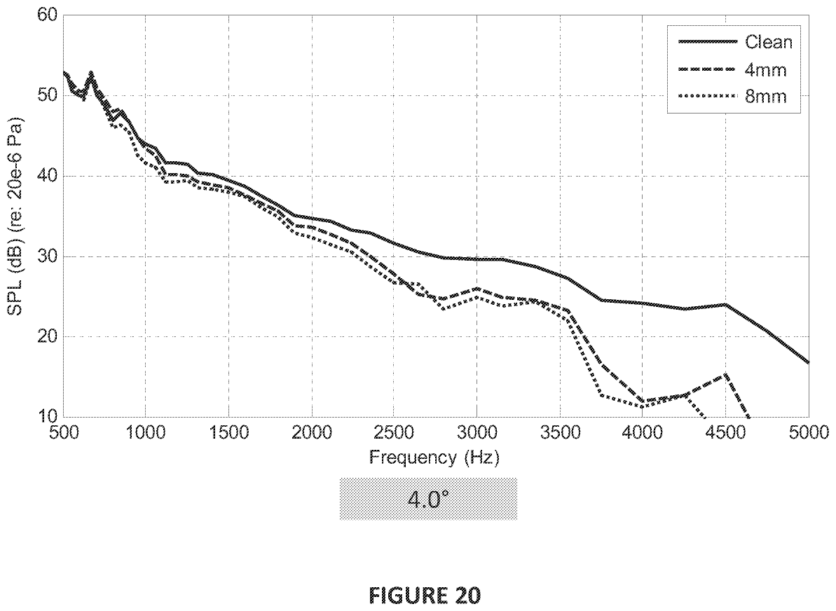

FIG. 20 shows the trailing edge noise reduction of Configurations 5 and 8 at an angle of attack of 4°. The change in height had a marginal effect on the noise reduction, with the fins of 8 mm height performing better across the frequency range.

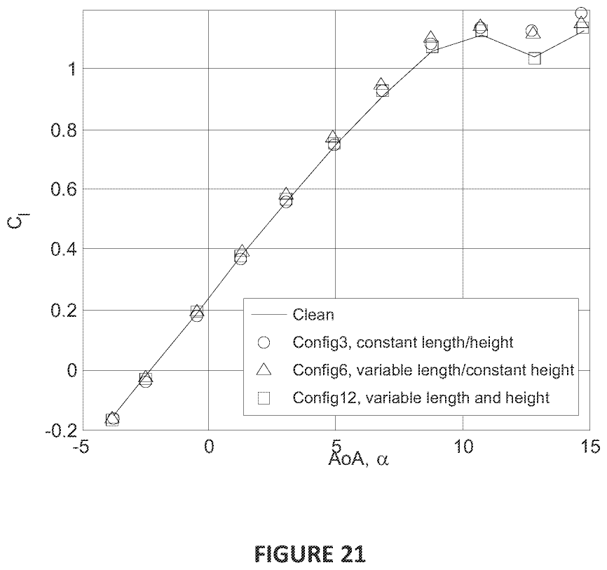

FIG. 21 shows the coefficient of lift (Cₗ) versus angle of attack (AoA, in degrees) of the airfoil of Configurations 3, 6, and 12, and the same airfoil without the noise reducer (clean). These configurations represent the same fin design but with different periodic spanwise variations in fin height and/or length. The periodic variations in fin length and/or height did not significantly affect lift.

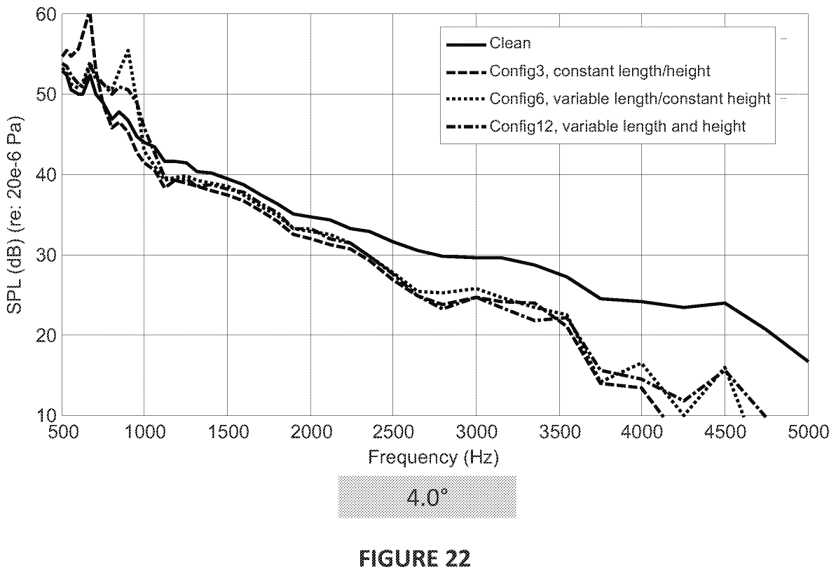

FIG. 22 shows the trailing edge noise reduction of Configurations 3, 6, and 12 at an angle of attack of 4°. The periodic spanwise variation of fin length and height had a marginal effect on the noise reduction, with the largest effect seen in the frequency range between 500 Hz and 1000 Hz. The streamwise development of length shifted the noise spike to approximately 900 Hz, and the streamwise development of length and height reduced the magnitude of this spike by about 5 dB.

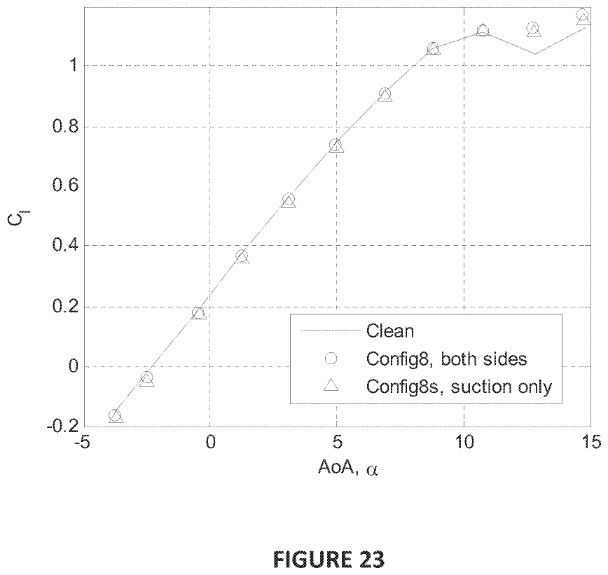

FIG. 23 shows the coefficient of lift (Cₗ) versus angle of attack (AoA, in degrees) of the airfoil of Configurations 8 and 8S, and the same airfoil without the noise reducer (clean). These configurations represent the same fin design and show the difference in applying the fins to one side versus both sides of the airfoil. Having the fins on the suction side only did not significantly affect lift.

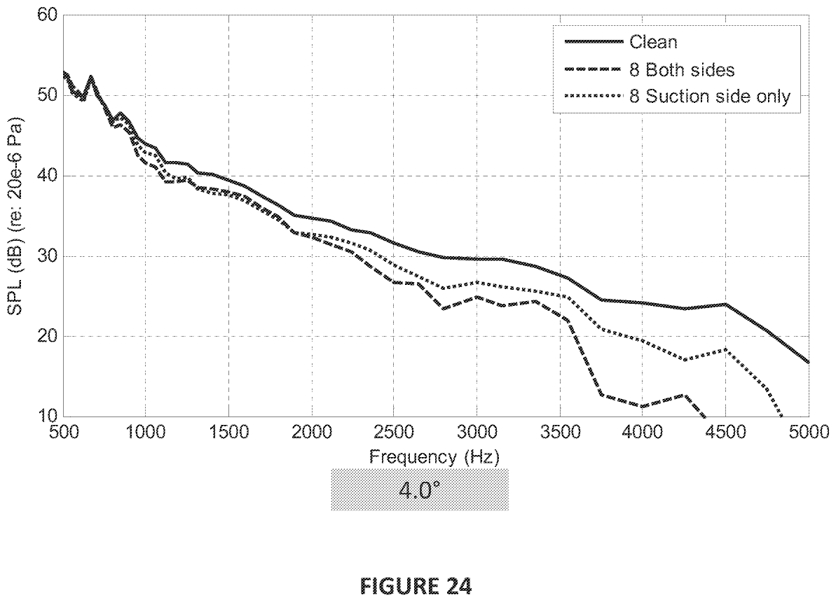

FIG. 24 shows the trailing edge noise reduction of Configurations 8 and 8S at an angle of attack of 4°. Removing the device from one side of the airfoil led to an approximate 50% decrease in the noise reduction, which demonstrates that the treatment should preferably be placed on both sides of the airfoil for maximum noise reduction.

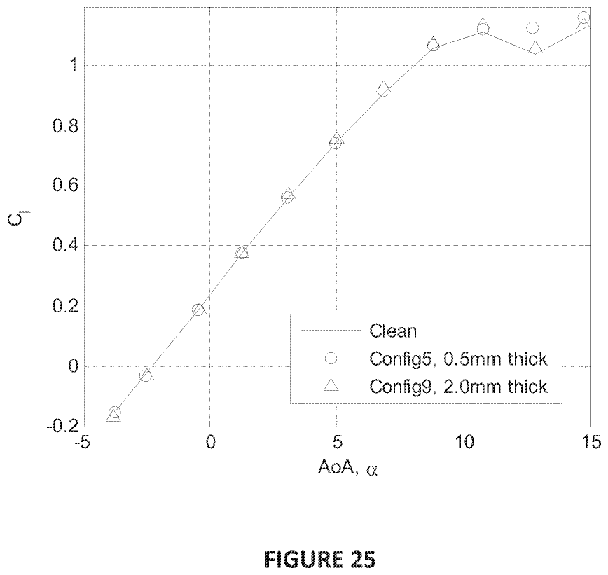

FIG. 25 shows the coefficient of lift (Cₗ) versus angle of attack (AoA, in degrees) of the airfoil of Configurations 5 and 9, and the same airfoil without the noise reducer (clean). These configurations represent the same fin design except that the fins are of different thickness. The thickness of the fins did not significantly affect lift.

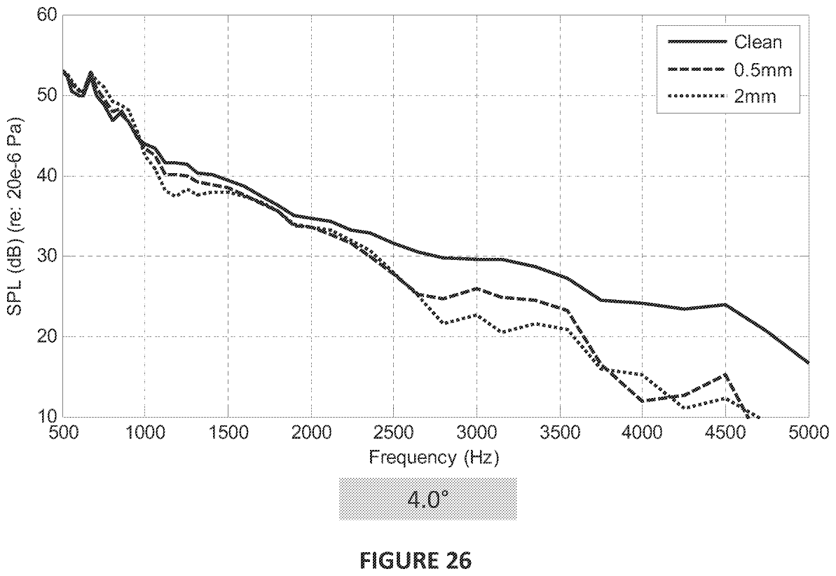

FIG. 26 shows the trailing edge noise reduction of Configurations 5 and 9 at an angle of attack of 4°. The thicker, 2 mm fins led to an increase in noise reduction in the frequency range between 2750 Hz and 3500 Hz.

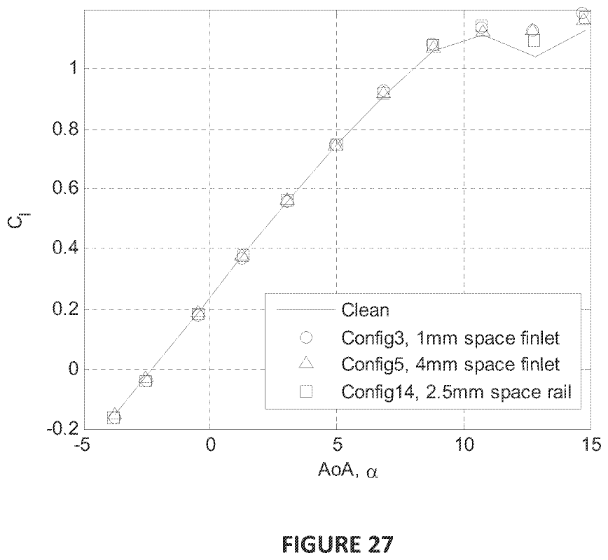

FIG. 27 shows the coefficient of lift (Cₗ) versus angle of attack (AoA, in degrees) of the airfoil of Configurations 3, 5 and 14, and the same airfoil without the noise reducer (clean). These configurations compare the results obtained using two different fin designs and one of the rail designs. The presence of fins or rails did not significantly affect lift.

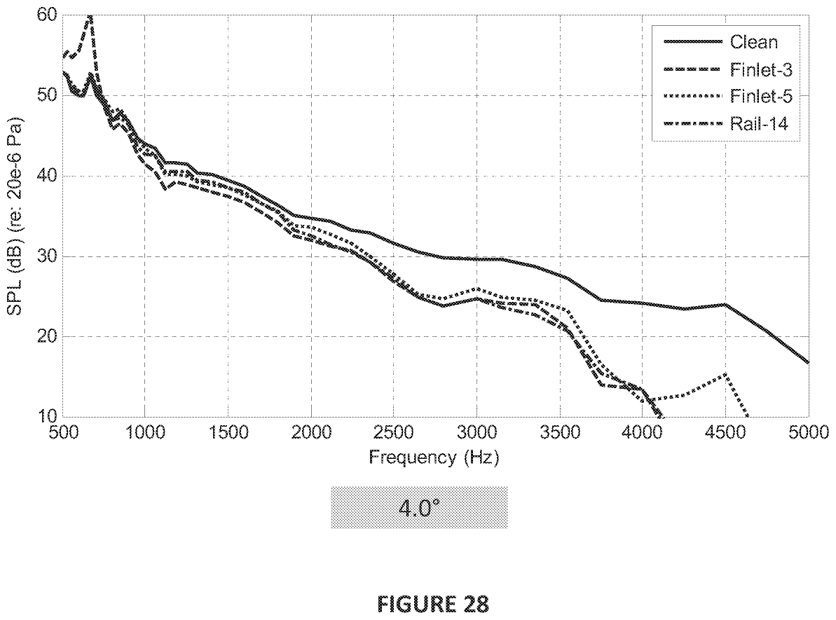

FIG. 28 shows the trailing edge noise reduction of Configurations 3, 5 and 14 at an angle of attack of 4°. Only marginal differences exist between the noise reduction profiles of the featured fin and rail configurations, which demonstrates that both configurations can be effective noise reducers.

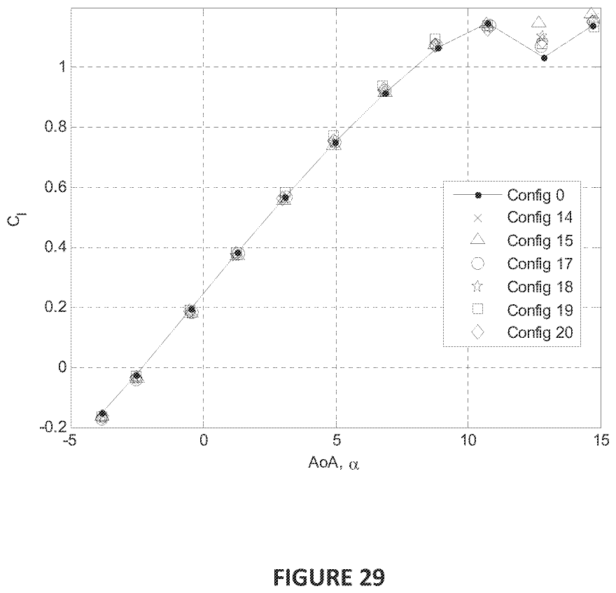

FIG. 29 shows the coefficient of lift (Cₗ) versus angle of attack (AoA, in degrees) of the airfoil of Configurations 14, 15, 17, 18, 19, and 20, and the same airfoil without the noise reducer (clean). These configurations represent a wide variety of rail designs. The presence of rails did not significantly affect lift.

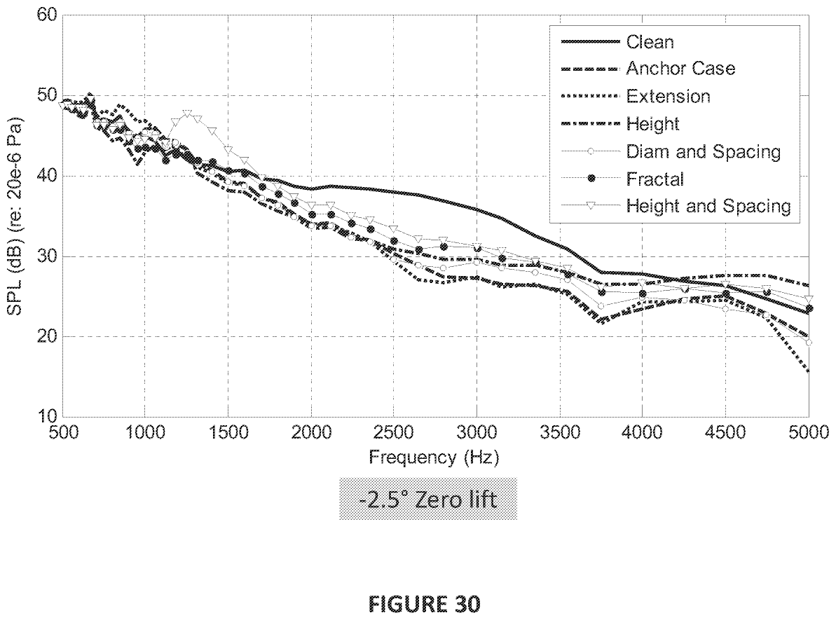

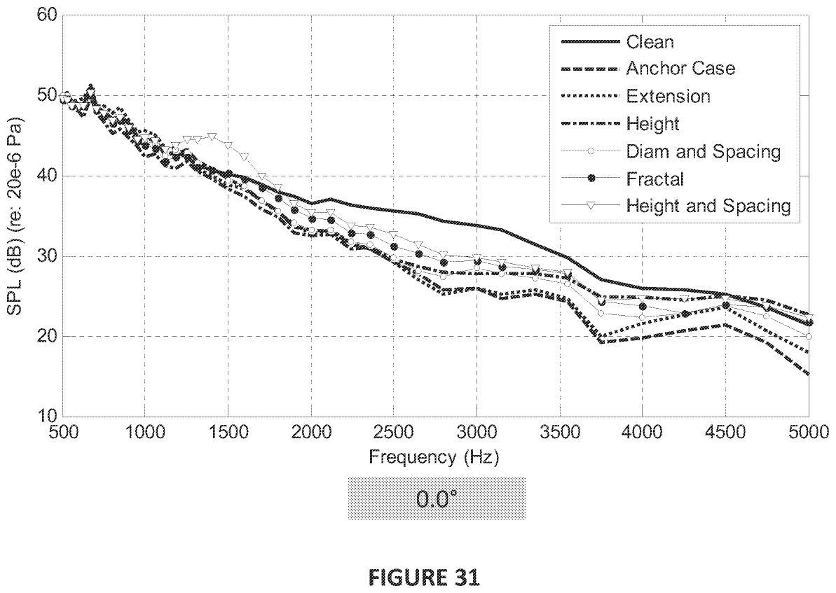

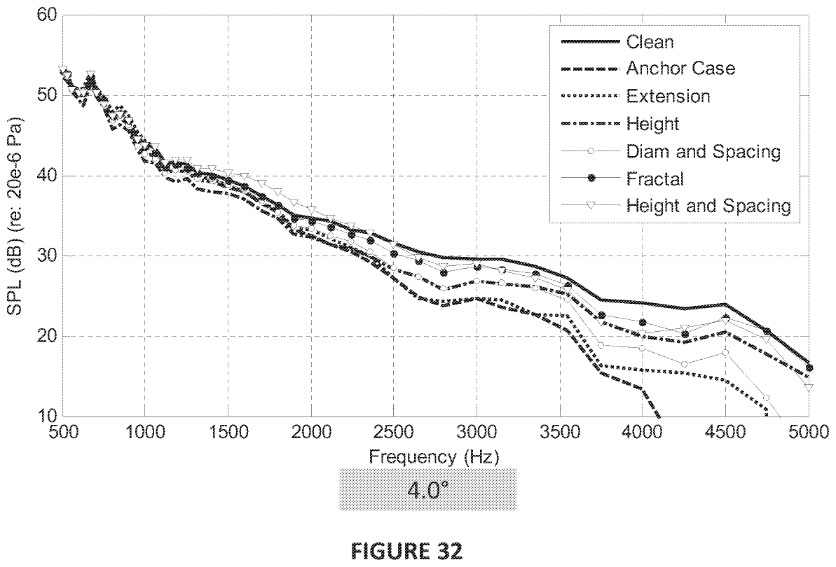

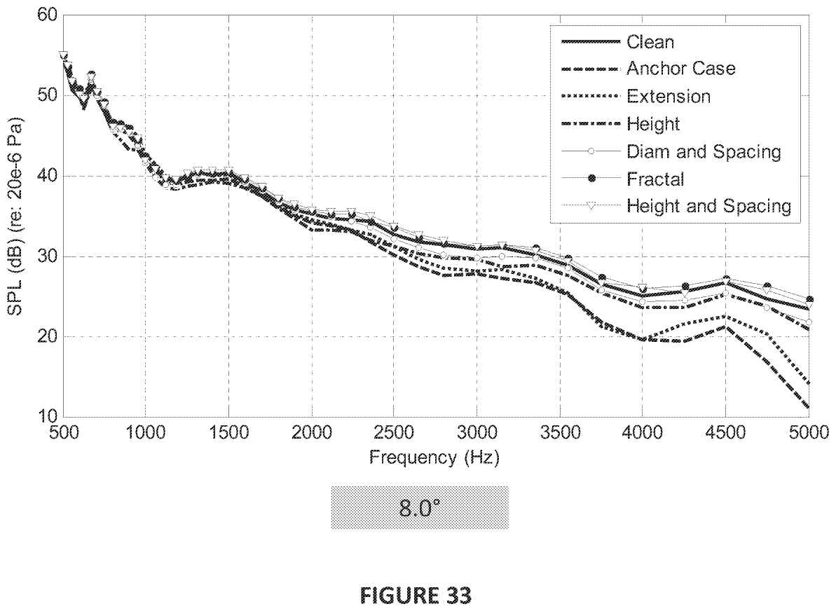

FIGS. 30-33 show the trailing edge noise reduction of Configurations 14, 15, 17, 18, 19, and 20 at an angle of attack of 2.5, 0, 4, and 8°, respectively. The effects of the geometric variables on noise reduction seen here follow the same trends as those displayed in previous figures featuring the different fin configurations.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

1. An airfoil comprising: a surface defining a pressure side, a suction side, a leading edge and a trailing edge each extending between a tip and a root;
a plurality of members distributed spanwise across said suction side;
each member increases in height from said leading edge to said trailing edge; and
each member reaches a maximum height at said trailing edge and then reduces in height for a predetermined distance downstream past said trailing edge to form a suction side trailing edge extension.

2. The airfoil of claim 1 further including a plurality of pressure side trailing edge extensions on said pressure side.

3. The airfoil of claim 2, wherein said pressure side trailing edge extensions are mirror images of said suction side trailing edge extensions.

4. The airfoil of claim 1, wherein each of the plurality of members has a maximum height of about 5-300% of the trailing edge boundary layer.

5. The airfoil of claim 1, wherein each of said members has a length in a direction parallel to air flow on said suction side.

6. The airfoil of claim 1, wherein said members are separated from each other by a distance of about 5-300% of the airfoil boundary layer thickness.

7. The airfoil of claim 1, wherein each of said suction side trailing edge extensions has a curved surface.

8. The airfoil of claim 2 wherein each of said pressure side trailing edge extensions has a curved surface.

9. The airfoil of claim 2, wherein each of said suction side trailing edge extensions has a curved surface and each of said pressure side trailing edge extensions has a curved surface.

10. The airfoil of claim 2, wherein each of said members are solid fins.

11. The airfoil of claim 7 wherein said suction side trailing edge extensions further include a linear edge connected to said curved surface.

12. The airfoil of claim 8, wherein said pressure side trailing edge extensions further include a linear edge connected to said curved surface.

13. The airfoil of claim 9, wherein each of said suction side trailing edge extensions further include a linear edge connected to said curved surface; each of said pressure side trailing edge extensions further include a linear edge connected to said curved surface; and said linear edges are a spaced distance apart.

14. A method for forming an airfoil having reduced noise in operation comprising the steps of:
a. providing an airfoil having an exterior surface defining a pressure side, a suction side, a leading edge and a trailing edge each extending between a tip and a root;
b. mounting a noise reducer on the suction side surface;
c. said noise reducer comprised of a plurality of members distributed spanwise across said suction side; each member increases in height from said leading edge to said trailing edge; and each member reaches a maximum height at said trailing edge and then reduces in height for a predetermined distance downstream past said trailing edge to form a suction side trailing edge extension.

15. The method of claim 14, wherein said members further include a plurality of pressure side trailing edge extensions on said pressure.

16. The method of claim 15, wherein said pressure side trailing edge extensions are mirror images of said suction side pressure side trailing edge extensions.

17. The method of claim 14, wherein each of said suction side trailing edge extensions has a curved surface.

18. The method of claim 15, wherein each of said pressure side trailing edge extensions has a curved surface.

19. The method of claim 15 wherein each of said suction side trailing edge extensions has a curved surface and each of said pressure side trailing edge extensions has a curved surface.

20. The method of claim 19, wherein each of said suction side trailing edge extensions further include a linear edge connected to said curved surface; each of said pressure side trailing edge extensions further include a linear edge connected to said curved surface; and said linear edges are a spaced distance apart.
